(19) United States
(12) Patent Application Publication
(10) Pub. No.: US 2006/0190184 A1
(43) Pub. Date: Aug. 24, 2006

(54) System and method using a visual or audio-visual programming environment to enable and optimize systems-level research in life sciences

(75) Inventors: Maciek Sasinowski, Williamsburg, VA (US); Krista Miller, Williamsburg, VA (US); Heather Sasinowska, Williamsburg, VA (US); Jason Miller, Williamsburg, VA (US)

Correspondence Address: GUERRY LEONARD GRUNE, 784 S VILLIER CT., VIRGINIA BEACH, VA, 23452, US

(73) Assignee: INCOGEN, Inc., Williamsburg, VA (US)

(21) Appl. No.: 11/064,302

(22) Filed: Feb. 23, 2005

(51) Int. Cl. G06F 19/00; G06F 17/21

(52) U.S. Cl. 702/19; 715/526

(57) ABSTRACT

The current invention provides a visual or audio-visual programming environment for life science and bioinformatics. It is based on the VIBE platform, which is a flexible, extensible, and integrated workflow construction and management platform. The current invention enables researchers to consolidate molecular profiling data from complementary experimental techniques, intelligently reduce the volume of the data, construct disease-specific molecular fingerprints, construct relationship networks among functionally significant genomic, transcriptomic, metabonomic, and proteomic data, integrate information from existing biological databases into those networks, optimize the process through iterative feedback loops, and to generate and validate hypotheses based on the above process. The uses of this integrative, systems-based approach include, but are not limited to, the identification of potential biomarkers, characterization and classification of diseases and pathogens, and discovery of drug targets.

### CROSS-REFERENCE TO RELATED APPLICATION

The following U.S. patent application, filed Jun. 19, 2004, is specifically and entirely incorporated herein by reference: U.S. patent application Ser. No. 10/872,056, entitled “A System and Method Using Visual or Audio-Visual Programming for Life Science Education and Research Purposes.”

### FIELD OF THE INVENTION

The present invention relates to the field of bioinformatics, and more specifically to a system and method for a visual or audio-visual programming and analysis tool designed for enabling systems-level research in the life sciences. The terminology “Visual Integrated Bioinformatics Environment—Systems Edition” (VIBE-SE) is used to describe the basic function of the software and present invention.

### BACKGROUND OF THE INVENTION

Recent advances in genomics and proteomics have greatly increased understanding of the molecular basis for the functions associated with organisms. However, the characterization of single genes or proteins has provided only limited insight and benefits toward early diagnoses, improved sub-typing and prognoses, and treatment of diseases such as cancer. To understand the intricate web of networks that makes up the biological functioning of life, one must try to decipher how a gene or protein fits into this dynamic environment with thousands of other genes and proteins. The interpretation of these dynamic systems is vastly more complex than a static system such as sequencing the human genome, which is linear. A complete understanding of biological phenomena can only be achieved through the melding of information and insights from technologies that characterize genes and proteins at the level of sequence, transcription, regulation, structure, function, kinetics, and localization. This integration of knowledge requires a departure from conventional approaches toward life science research and is only possible by combining known technologies and enabling knowledge exchange from traditionally divergent fields such as molecular biology, clinical research, computational science, physics, statistics, and hardware engineering.

Over the last decade, separate advances in those fields have laid the foundation for an attempt to undertake the enormously ambitious task of deciphering functions of complete biological systems. However, this goal can only be achieved in an environment that enables meaningful and efficient integration of knowledge and technology from those different fields. At the heart of this environment one can provide a sophisticated bioinformatics framework that allows researchers to combine their distinct expertise and most efficiently optimize their contributions toward a common goal. However, while most scientists agree that an integrated, systems approach is fundamentally necessary to fully understand the biological functions of life, often proponents of such approaches are vague about how they will overcome the enormous challenges of data overload and meaningful integration of vast, heterogeneous data sets.

There are a number of resources in the form of software applications implementing complex algorithms available for life science and bioinformatics analysis that exist both as web-enabled tools and as independent software modules. The use of many of these tools in complex analysis workflows and the visualization of the results, however, require a significant level of programming expertise. It is not efficient to integrate all of the modules for life science and bioinformatics analysis into a single monolithic and proprietary application, as the analytical methods used by researchers in this field are rapidly expanding and evolving. As new techniques are discovered for life science and bioinformatics, analytical software modules must be advanced to perform more complex analysis and data mining tasks.

Many researchers and private companies have attempted to produce an all-encompassing, monolithic solution for genomic and proteomic analysis that claims to provide all the necessary tools. For example TurboWorx® Inc. offers a tool known as TurboWorx Builder® for life science and bioinformatics analysis. Another commercial source exists from Scitegic, which provides a tool known as Pipeline Pilot for cheminformatics and an open-source effort known as Biopipe also exists. While some of the workflow capabilities of these platforms overlap with the VIBE platform (which supports the technology of the present invention), none of these platforms include the flexible, extensible and integrated bioinformatics analysis platform described herein that would enable researchers to consolidate molecular profiling data from complementary experimental techniques, intelligently reduce the volume of the data and construct disease-specific molecular fingerprints, construct relationship networks among functionally significant genomic and proteomic data, integrate information from existing biological databases into those networks, and provide direction for subsequent experiments to identify potential biomarkers and drug targets.

Hence, there is a need for an extensible, user-friendly programming and analysis environment which could integrate these software applications as they become available into a user-friendly programming environment which integrates appropriate software applications such that scientists and bioinformaticists can perform their tasks more efficiently without the additional requirement (and burden) of possessing expertise in computer programming.

Moreover, in addition to integrating and providing easy access to heterogeneous tools in such a manner, the programming and analysis environment should also enable the end user to understand the purpose and appropriate application of each tool as well as to provide the ability to decipher the results of the analysis and guide the user in extracting relevant knowledge from the data.

The following known art exists, but each is deficient in meeting the complete functionality outlined above.

US Patent Application 2003/0220928, to Durand, Wojcik, and Schachter, published Nov. 27, 2003, teaches a method for organizing genomic and proteomic information in a database having a plurality of data nodes and a plurality of links capable of binding data nodes two by two, genomic and proteomic information being stored in a plurality of independent databases, and an access method to access by query, the contents of a database organized by the preceding organizational method for a defined query. The method uses the steps of organizing the query in the form of a graph pattern having a plurality of nodes and a plurality of links binding the nodes two by two, the nodes and the links being taken in the set of data node types and links types respectively from the organized database, seeking the database of a set of nodes and links whose type corresponds to the query thus organized, the set of nodes and links forming a set of occurrences that assist in forming the graph pattern, and provisioning the terminal with the nodes and links. This invention differs from the present invention in many respects; primarily, VIBE-SE utilizes toolkits (sets of tools that are conceptually related) of modular workflow components, such as statistical analysis. For the various categories of statistical and numerical analysis, several different algorithms may exist. These algorithms may be implemented in a variety of programming languages (e.g., C, Fortran, R, S-Plus, Matlab, etc), some of which will require software components from the existing VIBE platform to interface with their environments or search engines. The algorithms are integrated into a workflow platform and can be used with user defined workflows in series, parallel, in conjunction with other algorithms, interchangeably with other algorithms, etc., all based on the need(s) of the user/researcher. The invention described herewithin provides data which is not reduced in volume and also does not provide analysis with the navigation portion of the software tool.

U.S. Patent Application 2003/0208322, to Aoki, Hoff, and Shams, published Nov. 6, 2003, teaches an apparatus, method, and computer program product for plotting proteomic and genomic data. This patent application specifically teaches an apparatus comprising a computer system for generating data to display the data in a visual format. The computer system receives a set of proteomic and genomic data including data samples and schemes for partitioning the data samples into data partitions. Various operations are performed by the computer system in response to user commands, including adjusting the view of partition schemes in response to the selection of a particular partition scheme in order to allow a user to visually detect correlations among data. The system also allows for the performance of set operations on the proteomic and genomic data, and for displaying the results. Additionally, the computer system allows for operations for determining partition schemes and partitions in which a particular data sample are located, and for generating and modifying partition schemes. This invention differs from the present invention in that it provides only a data viewer as the main feature or focus. Although the VIBE platform and specifically VIBE-SE include data viewers, the viewers are not primary features of the software or the invention.

US Patent Application 2003/0176976, to Gardner, published Sep. 18, 2003, teaches a bioinformatics system and method for integrated processing of biological data. According to one embodiment, the invention provides an interlocking series of target identification, target validation, lead identification, and lead optimization modules in a discovery platform oriented around specific components of the drug discovery process. The discovery platform of the invention utilizes genomic, proteomic, and other biological data stored in structured as well as unstructured databases. According to another embodiment, the invention provides overall platform/architecture with an integration approach for searching and processing the data stored in the structured as well as unstructured databases. According to a further embodiment, the invention provides a user interface, affording users the ability to access and process tasks for the drug discovery process. The subject invention of this application does not provide a methodology or enablement to link data and databases with a pipeline or pipeline-like structure that would enable users not skilled in programming capabilities to obtain the specific data they require, but rather provides an intuitive user interface that requires user expertise beyond the scope of the present invention. The invention described herewithin deals primarily with data that is required for a later stage of the discovery process—it is not workflow specific nor does it contain a query engine, a viewer, nor was it designed for various numbers and types of users.

US Patent Application 2002/0188408, to Nabhan, published on Dec. 12, 2002, provides for an invention where bioinformatics data is accepted from corresponding bioinformatics data suppliers. A subset of the bioinformatics data is analyzed to generate bioinformatics data analysis results. The bioinformatics data analysis results are provided to at least one bioinformatics data analysis results customer. The bioinformatics data suppliers that supplied the subset of the bioinformatics data are compensated in return for their supplying the subset of the bioinformatics data that was analyzed to generate the bioinformatics data analysis results. These results are then provided to at least one bioinformatics data analysis results customer. The invention is tailored to providing users with primarily individual data sets that are purchased on an as needed basis and is limited to the data suppliers' database. The system is primarily designed for a brokering service that is available for users willing to subscribe to the data supplier, whereas VIBE-SE is focused on workflow creation, optimization, and analysis.

U.S. Pat. No. 6,706,529, to Schneider, Hall, and Peterson, and assigned to Target Discovery, Inc., granted Mar. 16, 2004, provides a method for protein sequencing using mass spectrometry. Also provided in this invention are protein-labeling agents and labeled proteins that are may be quite useful in conjunction with the present invention. The invention includes a wet-lab protocol useful which is useful in generating protein sequences. Such sequences may be useful in providing data for VIBE-SE workflow analysis, but the invention is disjoint from VIBE-SE.

U.S. Pat. No. 6,675,104, by Paulse, Gavin, Braginsky, Rich, and Fung, and assigned to Ciphergen Biosystems, Inc., granted Jan. 6, 2004, provides a method that analyzes mass spectra using a digital computer. The method includes entering into a digital computer a data set obtained from mass spectra from a plurality of samples. Each sample has been assigned or is to be assigned to a class within a class set. Each class set contains two or more classes where each class is characterized by a different biological status. A classification model is then formed. The classification model discriminates between the classes in the class set. This invention differs from the present invention in that the VIBE-SE methodology allows for not only analyzing mass spectra but allows for providing data set solutions in combination with other heterogeneous analysis techniques that include, for example, gene and protein sequence data analysis of gels, etc., as well as mass spectra analysis, etc. VIBE-SE utilizes a user-definable and extensible modular approach toward the analysis that includes analysis options provided by separate modules including signal processing, variable selection, and on-demand classification. The method of the present invention provides a workflow creation and optimization platform unlike that of any other known approach. The invention described herewithin does not include data optimization routines, does not include error minimization of the workflow, nor does it allow the workflow to be changed.

U.S. Pat. No. 6,691,109, by Bjornson, Carriero, Sherman, Weston, and Wing, and assigned to Turbo Worx, Inc., granted Feb. 10, 2004, provides a computer-implemented method and apparatus for performing remote sequence comparison. Multiple query sequences are searched against one or more sequence databases. The method includes partitioning the query sequences and partitioning the sequence databases into smaller subsets, assigning searching tasks to members of a group of computers working in parallel, each member further dividing a task into related tasks on a virtual memory shared memory bulletin board for providing high-performance and high-speed sequence comparison. Again, the workflow sequence and modular approach offered by VIBE-SE and techniques associated with remote sequence comparisons greatly distinguish the present invention. This invention described herewithin focuses on a parallelization to increase optimization of a single (widely used) algorythm and does not provide for workflow capabilities.

US Patent Application 2004/0143571, by Bjornson, Carriero, Sherman, Weston, and Wing, and assigned to Turbo Worx, Inc., published on Jul. 22, 2004, teaches a computer-implemented method and apparatus of searching a plurality of queries against at least one database containing a plurality of records. The plurality of queries is partitioned into a set of smaller subsets of queries. The at least one database is portioned into a set of smaller subdatabases. Searching tasks to be performed are designated by associating each of said subsets of queries with one or more of said subdatabases, assigning each searching task to one of a group of computers operating in parallel, wherein each member of the group of computers operating in parallel has at least one searching task assigned thereto, and executing at least some of the assigned searching tasks using the group of computers operating in parallel. At least one of the searching tasks is further divided into two or smaller searching tasks, and the two or more smaller tasks are designated as related tasks on a virtual shared memory bulletin board. Search results are collected from the executed searching tasks and a unified search result is generated in accordance with the collected search results. The partitioning of the queries and the partitioning of the database are done by one or more members of the group of computers operating in parallel.

International Patent Application, WO 02/039486, by the National Center for Genome Resources, published May 16, 2002, teaches a system for the integration of heterogeneous bioinformatics software tools and databases that allows interoperation of components adhering to a minimal set of standards. The system includes a software platform, one or more interface-based data models, and one or more component services. The invention utilizes an object oriented programming language to provide flexibility, synchronization, dynamic discovery, and The Client Environment comprises a common user interface. Various embodiments disclose particular data models for use in the subject areas of bioinformatics and plant biology. The flexibility and improvements this invention provides over traditional object oriented approaches has use for other fields not concerned with bioinformatics and biology. However, this invention differs from the present invention in that it does not provide optimization capabilities for its integration of data from various sources nor does it provide for constructing a workflow with a visual user interface that includes the pipeline necessary for connecting modules that are compatible with each other.

These and other differences and deficiencies as illustrated above are apparent in the existing body of known art. Features not developed in previous inventions that are prevalent with VIBE-SE include: a focus to provide the user with infrastructure for the creation of visual and audio-visual workflows for systems-level research wherein the user-definable workflow is optimized. Therefore, it is desirable to provide a technique for a flexible, extensible and integrated life science analysis platform that enables researchers to consolidate molecular profiling data from complementary experimental techniques, intelligently reduce the volume of the data and construct disease-specific molecular fingerprints, construct relationship networks among functionally significant genomic, transcriptomic, metabonomic, and proteomic data, integrate information from existing biological databases into those networks, optimize the constructed workflows, and provide direction for subsequent experiments that identify potential biomarkers and drug targets.

### SUMMARY OF INVENTION

The present invention relates to the field of life sciences, and more specifically to a system and method for a visual or audio-visual programming and analysis tool designed for enabling and optimizing systems-level research in any of the life sciences. The present invention provides a set of unique and novel features that function on INCOGEN's existing Visual Integrated Bioinformatics Environment (VIBE) software, which successfully demonstrates the application of visual programming for life science and bioinformatics in a research environment. VIBE is a state-of-the-art, drag-and-drop analysis workflow management environment and that has been established as a premier software application in the field of life science workflow management during the last several years. The VIBE system interfaces with a variety of computing environments, including high-throughput platforms such as Sun Microsystems'® Grid Engine and the TimeLogic DeCypher® bioinformatics hardware accelerator platform. The rich visualization and data mining environments in combination with the sophisticated multi-tiered server architecture offer life science researchers and bioinformaticists a powerful system for data analysis, data mining and knowledge discovery. The VIBE Software Development Kit (SDK) enhances the VIBE environment with user-level extensibility.

The features of VIBE include, but are not limited to, visual workflow creation, customization, and management, robust toolkits, efficient drag-and-drop analysis pipeline construction, visual implementation of software algorithms, data filtering on simple or complex criteria, distributed multi-user support, interactive or batch mode module execution, user-editable representation of pipelines in XML, state-of-the-art interactive visualization tools, real-time visualization of dataflow between the modules in the workflow pipeline, intuitive and user-friendly data representation, and archiving of workflows allowing for future use. The present invention pertains to the features and capabilities layered upon the existing VIBE platform and in fact is built upon the existing VIBE client-server platform for extensible, modular visual programming for workflow construction, optimization, execution, and management.

The terminology “Visual Integrated Bioinformatics Environment—Systems Edition” (VIBE-SE) is used to describe the basic function of the software and present invention. In addition to the features of VIBE described above, VIBE-SE includes features that include systems biology functions and toolkits (sets of tools that are conceptually related) of modular workflow components, including statistical analysis packages for various categories of statistical and numerical analysis. As analysis is performed, many algorithms and even several versions of a given algorithm may exist. These algorithms may be implemented in a variety of programming languages (e.g., C, Fortran, etc.) or as scripts (e.g., R, S-Plus, Matlab, etc.), which may require software components in VIBE and VIBE-SE to interface with their existing environments or engines. The algorithms are integrated into the workflow platform and can be used in workflows in series, in parallel, and/or in conjunction with in-house or third-party databases or programs as the user/researcher sees fit.

Examples of algorithms/resources that may be integrated in the VIBE-SE application are presented below. These algorithms/resources are grouped by category in a logical hierarchy.
i. Signal processing
   1. Noise reduction
      a. Ringing detection
      b. Variance characterization
      c. Background subtraction
      d. Smoothing
   2. Mass calibration
      a. Dejittering
      b. Normalization
   3. Feature detection
      a. Peak-picking filters
      b. Shaping filters
ii. Profile construction
   1. Variable selection
      a. Stepwise discriminant analysis
   2. Dissimilarity measures
      a. Minkowski metrics
      b. Power divergence statistics
   3. Construction of representation
      a. Multi-dimensional scaling (MDS)
   4. Dimension reduction
      a. PCA
      b. Discriminant coordinates
iii. Classification and validation
   1. Profile-based classifiers
      a. Linear discriminant analysis (LDA)
   2. Distance-based classifiers
      a. Nearest-neighbors
   3. Cross-validation
      a. Leave-V-out validation scheme
iv. Integration of external resources
   1. Gene and protein sequence databases
      a. NCBI
      b. SwissProt
      c. Secreted Protein Database
   2. Publication
      a. PubMed
      b. OMIM
   3. Gene Ontology
   4. Protein interactions and pathways
      a. KEGG
      b. BIND
      c. BRENDA
      d. TRANSPATH
v. Network reverse engineering
   1. Application of similarity measure
   2. Determination of similarity matrices
   3. Construction of constrained similarity matrices
   4. Integration and weighting of data types from different experimental platforms
   5. Performance assessment
   6. Comparison of reverse engineered networks
vi. Visualization
   1. Signal visualization
      a. Waveform
      b. Block interpretive
      c. Tabular
   2. Statistical modeling and classification
      a. Tabular
      b. Graphical
   3. Comparison analysis
      a. Pair-wise and multiple alignment
         Using mass spectrometry as an example, features regarding the visualization and interactive manipulation aspects of the inventive VIBE-SE software application may include:
         1. Views
i. Histogram views of:
   Individual spectrum
   Animated sequences of spectra
   Averaging of a group of spectra
ii. Composite views of multiple histograms, side-by-side (“stacked”) or overlaid
iii. Overlay of statistical data on histogram(s) (e.g. peak variance or discriminating power)
iv. Spreadsheet-style view of selected spectra
v. “Heat” plots to display a large number of spectra on the same plot
vi. 2-D color plot of Fourier-transformed spectra for signal processing
vii. 3-D plots for discriminant coordinate projections, principal component projections, etc.
   2. Manipulation of Data
i. Widen or narrow (zoom) the visual area of the spectra, image or profile (e.g., in DC/PC coordinates)
ii. Select a subset of spectra from or across groups, patients and replicas
iii. Provide activation links from profile construction to spectral views (e.g., bring up the patient spectrum when the user selects the corresponding profile on DC/PC/MDS plane)
iv. Range-restrict any view
v. Apply additional mathematical tools such as correlation or window averaging
vi. Provide a connection between profile construction and signal processing views and parameters, as well as with classification errors for individual patients or groups
vii. Change scales for the plot (e.g. linear, logarithmic, or differential)

### DESCRIPTION OF THE INVENTION

The current invention, which has been incorporated into an existing software application, is known as “Visual Integrated Bioinformatics Environment—Systems Edition” (VIBE-SE). This invention provides a systems biology researcher with a flexible, extensible, and integrated bioinformatics analysis platform that enables them to consolidate molecular profiling data from complementary experimental techniques, intelligently reduce the volume of the data and construct disease-specific molecular fingerprints, construct relationship networks among functionally significant genomic and proteomic data, integrate information from existing biological databases into those networks, optimize the workflow, and provide direction for subsequent experiments to identify potential biomarkers and drug targets by utilizing the optimized workflow. The existing VIBE workflow environment supports the foundation upon which VIBE-SE incorporates these additional features. VIBE-SE utilizes the VIBE platform and supporting features of VIBE, which are fully described below:

VIBE Enterprise Architecture:

The design of VIBE incorporates Java 2 Enterprise Edition (J2EE) object-oriented architecture standards. These standards yield a robust and flexible multi-tiered system. The multi-tiered design allows the system to be scalable and extensible and provides many design advantages, including;
(a) Reduced overall system cost without loss of performance or flexibility through modular, distributed components.
(b) Isolation of the client from the business logic and storage format of the data, allowing flexibility in the middle layers of the system (application server configuration, database servers and schemas) without modifications to the client.
(c) Ability to distribute the application layer to increase system performance.
(d) Independent analysis on the application server layer without client intervention.

The VIBE system can be described and characterized by two parts; namely, the server system and the client system. Main services provided by the server system include, but are not limited to, remote execution of computationally intensive tasks as per the user's preferences, storage of workflow pipelines, storage of modules in a central repository so that they are available to all the clients connecting to the server, management of algorithms and databases containing data for sequence comparison and other analyses. Main services provided by the client system include, but are not limited to, providing a visual programming environment for workflow pipeline development, modification and testing. Moreover, the educational features of the current invention are layered primarily over the client system, which makes the system desirable for life science educational and research purposes.

Visual Workflow Creation:

VIBE provides a graphical drag-and-drop interface to create workflows or pipelines from a wide selection of tools and algorithms. The modules for similarity searches are arranged in a toolbar format. The groupings are determined by arrangement of an XML file that can be customized by the user.

Analysis modules are grouped by type and presented to users as icons on a toolbar or a tree view. The icons represent modules that can be dragged onto the workspace and connected to other modules to generate a workflow pipeline for data analysis. Users can choose among modules including but not limited to: data input, sequence similarity searches, sequence alignment, databases, utilities such as email notification agents and data filters, model building and searching, and visualization tools. The interface shown indicates an embedded multimedia framework, toolbar arrangement, and service execution log.

Each analysis module contains a set of default parameters and may be executed with the default settings. The parameters can also be easily adjusted through a separate tabular interface. The program also provides detailed descriptions in hypertext format for all analysis modules. This description of individual modules can be edited by users for further clarification or to add notes regarding results of tests conducted using these modules or description of changes made to these modules by a user.

VIBE provides connection validation at design time to assist users in creating valid workflows and to reduce the probability of a runtime error or conflict due to incompatibility of modules. Only those modules that are compatible with each other are allowed to be connected to form a workflow pipeline. An error dialog box is displayed if a user tries to join two modules that are not compatible with each other. This error dialogue box (test results) will contain an intuitive message to resolve the error(s) and/or will contain a link to an appropriate resource that will help the user to determine the cause of the error.

Once generated, a workflow pipeline can be saved with XML on the client computer or on any network-accessible machine. A pipeline can be saved before execution as a template (that is, with no data associated with it) and used later with other input data sets or it can be saved as an archive during or after the execution to capture all associated data and results that exist at that time. The user can re-open the saved archive at any later point and view the saved results or conduct further analysis. Multiple workspaces also allow users to design new pipelines while continuing to monitor the progress of active pipelines that are being executed. Through the simple graphical interface, users may employ tools such as alert modules and data filter modules to diverge data flow. A user could stop the pipeline while in execution and save it along with the partly processed data and later resume execution from the same point. The flow of data during the execution of a workflow pipeline can be observed visually.

State-of-the-art, interactive visualization tools are available for each analysis module to efficiently and interactively present the user with the most important results of each analysis.

VIBE SDK (Software Development Kit):

Due to the continuously evolving nature of the life science and bioinformatics fields, new algorithms and comparison techniques are becoming available very rapidly. Modules that are incorporated within life sciences or bioinformatics software often quickly become obsolete due to the progressive availability of better applications and modules for data analysis. The VIBE platform enables the user to incorporate these new modules and independent applications into workflow pipelines with very little effort and essentially no programming expertise. This technological innovation of the modular architecture of the software makes the system a powerful and extensible framework and will allow the incorporation of additional tools as they become available.

The VIBE software includes a software development kit (SDK) that allows users to incorporate their own tools or third party modules through a simple set of public interfaces. Due to the interdisciplinary nature of bioinformatics, it has been an unfortunate necessity for researchers to have both biological knowledge and computational skills to not only perform analysis using tools, but also to develop their own models and utilities for enhancing the collection of available methods. Through the VIBE SDK, users can very quickly add their own specialized tools to a pipeline for use with existing tools and datasets.

The VIBE SDK exposes an integrated Application Programming Interface (iAPI) to the system via several succinct Java classes and their methods accompanied with extensive documentation and guidelines for using the SDK. The VIBE SDK provides mechanisms for adding tools that are executed locally on the client's machine, that are executed remotely through one or more VIBE servers, and that are accessible via a web-enabled interface such as SOAP (Simple Object Access Protocol) or CGI (Common Gateway Interface). It also provides the ability to add visualization tools or process utilities for execution within the VIBE client interface itself

Sharing:

The enterprise architecture of VIBE described above allows users of the system to share the workflow pipelines (with or without data) and results of the workflow pipeline analysis among themselves. Thus, researchers may advance their work on already available results and also share their results and workflow pipeline(s) (with or without data) with fellow researchers and students at anytime and anywhere through the convenience allowed by enterprise architecture.

Features of VIBE-SE (Present Invention)

The previous description provides information regarding some of the fundamental features of the VIBE platform that are necessary for supporting the present invention. The present invention, known as “Visual Integrated Bioinformatics Environment—Systems Edition” (VIBE-SE), augments VIBE with features that have been outlined above and are necessary to allow for an ideal software platform that life scientists and technicians can readily utilize. The features are fully explained below;

VIBE-SE contains toolkits (sets of tools that are conceptually related) of modular workflow components, including statistical analysis packages for various categories of statistical and numerical analysis. As analysis is performed, many algorithms and even several versions of a given algorithm may exist. These algorithms may be implemented in a variety of programming languages (e.g., C, Fortran) or as scripts (e.g., R, S-Plus, Matlab, etc), which may require software components in VIBE and VIBE-SE to interface with other existing environments or engines. The algorithms are integrated into the workflow platform and can be used in workflows in series, in parallel, in conjunction with in-house or third-party databases or programs as the user/researcher sees fit. Each individual algorithm will optionally be optimized as well as the entire workflow to yield the best analysis results.

Toolkits developed by INCOGEN for VIBE-SE can be tailored to or combined for specific uses such as integrative approaches to disease profiling and diagnostics. If there are persistent results, the user may select specific data (e.g., from a particular database or computer file). The VIBE-SE software can also be augmented with computationally intensive tools that employ various heuristics to provide estimates for time to completion of the requested analysis. In addition, interactive algorithms may employ a mechanism for providing a user with a preview of the current results and an opportunity to tailor the algorithm's execution for subsequent processing.

Visualization features are specific to each life science data type incorporated into the system. Examples that are applicable to mass spectrometry data include histogram views of individual spectra, animated sequences of spectra as well as averages of a group of spectra. Additional mass spectrometry-specific visualization features include composite views of multiple histograms, side-by-side (“stacked”) or overlaid statistical data on histogram(s) (e.g., peak variance or discriminating power), and “heat” plots. Also available are spreadsheet-style views of selected spectra with 2-D color plots of Fourier-transformed spectra for signal processing and 3-D plots for discriminant coordinate projections, principal component projections, etc. View manipulation with VIBE-SE is another feature that allows for widening or narrowing (zoom feature) the visual area of the spectra, image or profile (e.g., in DC/PC coordinates). The user may also select a subset of spectra from or across groups, patients and replicas. Activation links can be provided from profile construction to spectral views (e.g., bring up the patient spectrum when the user selects the corresponding profile on a DC/PC/MDS plane). View manipulation may continue by range-restriction of any view and application of additional mathematical tools such as correlation or window averaging is also provided. Additional visualization tools with the same level of sophistication for other data types are also provided as required by the user. In some instances, it may be useful or necessary to provide a connection between profile construction and signal processing views and parameters, as well as for classification errors of individual patients or groups. Changing scales for the plot (e.g. linear, logarithmic, or differential) is another useful feature of the visualization tools.

Additional features regarding primarily the visualization portion of the software allow for the employment of a “smart loading” capability on large datasets to optimize resource utilization while satisfying user view/processing requests. The ability to combine data profiles from a variety of sources/types (data merging/concatenation) is a unique and novel feature provided by the VIBE-SE tool. Several examples of the visualization results of such tools are found in FIGS. 7-11.

### BRIEF DESCRIPTION OF THE DRAWINGS

FIG. 1 is a schematic illustrating a system for visual or audio visual programming.

FIG. 2 is a screen capture of an error message with tree arrangement of Modules with a Module Details Panel.

FIG. 3 is a representation of the VIBE-SE Enterprise Architecture.

FIG. 4 is a flowchart representing a typical use of the VIBE-SE application.

FIG. 5 is a screen capture of a Graphical User Interface for VIBE-SE with Embedded Multimedia Framework, Toolbar and Pipeline Arrangement Providing for a Hidden Markov Model and Search Technique.

FIG. 6 is a representation of VIBE-SE System Approach to Diagnostics and Disease Marker Identification.

FIG. 7 is a workflow diagram of the three major components in the classification of profiling data (signal processing, profile construction, and discrimination/classification) and representative modules within each of the three components for a diagnostic relevant reduction of variables.

FIG. 8 is a screen capture that shows the data view capabilities for signal processing modules available to VIBE-SE users allowing for refined resolution analysis and enhancement. In this case the refinement is directed to mass spectrometry data.

FIG. 9 is an interactive viewer showing the annotation of sequence data with information from a variety of different algorithms. In this case, the data is associated with restriction enzymes and associated protein sequences. The viewer allows for browsing, editing, filtering, printing and saving the results.

FIG. 10 is an interactive SimViewer showing results from any of several similarity search algorithms. The viewer allows browsing, editing, filtering, printing and saving of results and provides links from data items to external resources for additional annotation.

FIG. 11 is an interactive MSA viewer showing results from any of several multiple (protein) sequence alignment algorithms. The viewer allows browsing, filtering, printing and saving the results.

FIG. 12 is a screen capture of a “Cluster Viewer” which is an interactive viewer showing results from configurable statistical clustering techniques applied to numerical datasets. In this example, the numerical datasets are gene expression profiles. The viewer allows for browsing, filtering and exporting of results as well as reclustering with adjusted algorithm parameters.

### DETAILED DESCRIPTION OF THE DRAWINGS

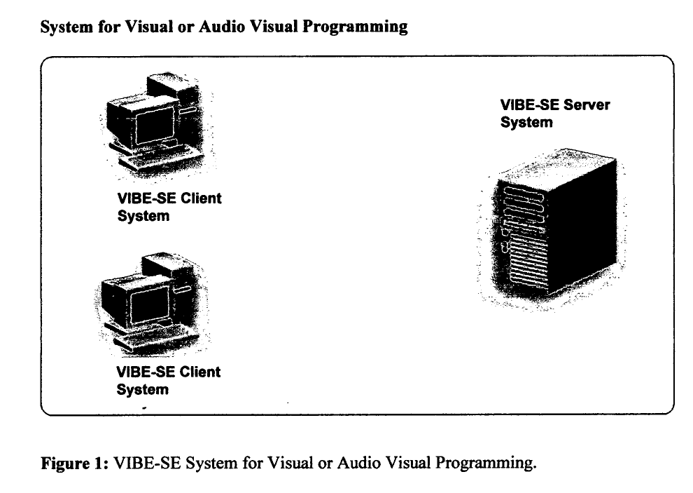

FIG. 1 is a schematic diagram of the system comprising visual or audio-visual programming environment of the current invention. The system could have zero or more server(s) and one or more client(s).

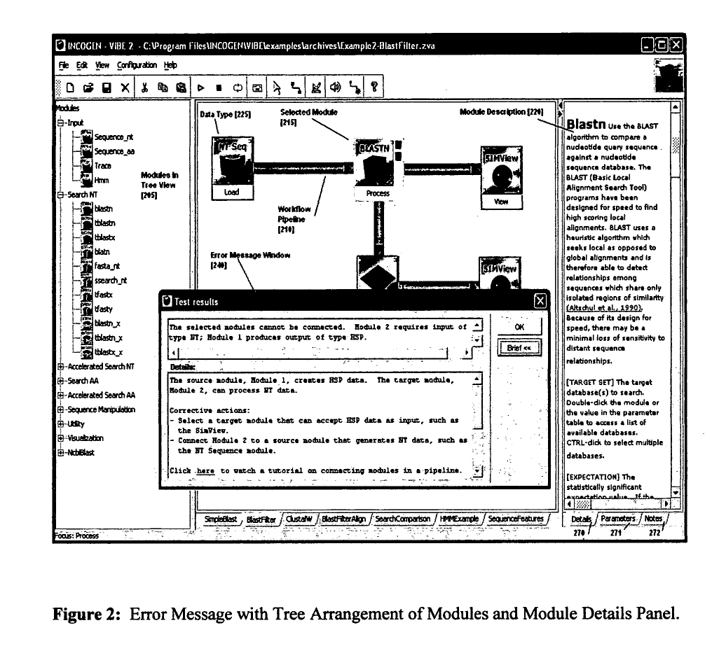

FIG. 2 is a screenshot of VIBE-SE with a user error message, tree arrangement of modules, and a module details panel. FIG. 2 includes an error message (240) indicating that a user is trying to join two incompatible modules in a workflow pipeline (210). In this example, module 1 creates high-scoring pairs (HSP) data, representing results from a sequence similarity search; the target module, module 2, however, can only process raw nucleotide (NT) data. Only modules that are compatible can be connected within a workflow pipeline. The error message window includes a hyperlink to allow the user to connect to an appropriate tutorial that will explain the error and aid the user in avoiding the error in the future. FIG. 2, in the left window, displays the modules in an expandable tree view (205). The right window displays the module description (220) of the selected module (215). Clicking on the Details tab (270) displays the module details as displayed in the figure. Clicking on the Parameters tab (271) displays the module parameters, which can be modified by the user, and clicking on the Notes tab (272) displays the user-editable notes regarding the workflow pipeline or module.

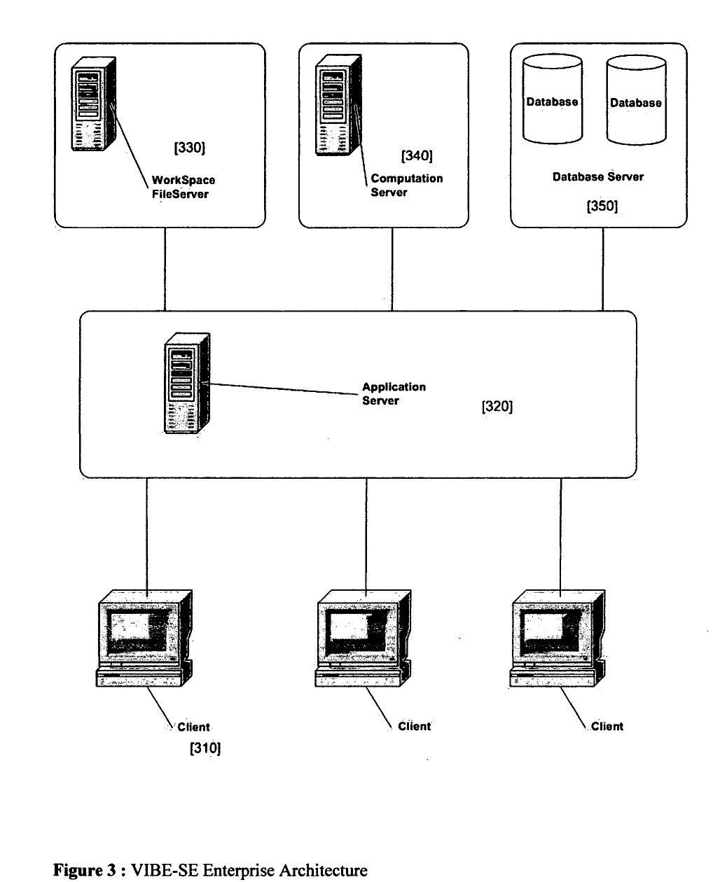

FIG. 3 is a schematic diagram representing the Enterprise Architecture of VIBE-SE. The VIBE-SE clients (310) are connected to the VIBE-SE Application Server (320) which in turn is connected to database server (350), computation server (340) and workspace server (330), which could all reside on the same computer or within the application server itself. Computationally intensive tasks are sent to the computation server during the execution of the workflow. Results are stored on the application server while archived and shared workflow pipelines are stored in the workspace server.

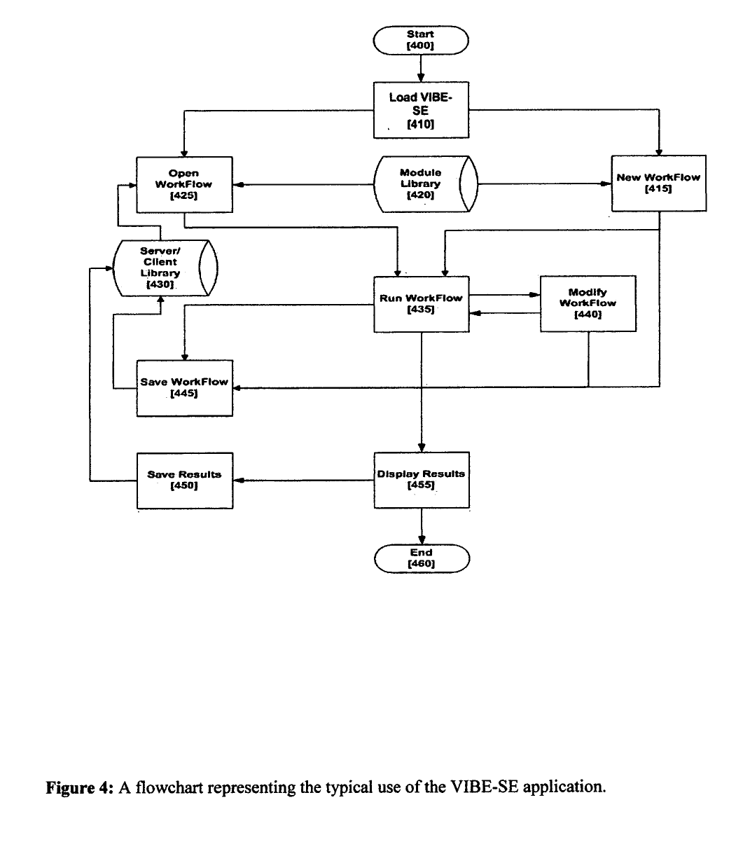

FIG. 4 is the flowchart representing a typical use of the VIBE-SE application. When a user first loads the VIBE-SE client (410) she/he has an option of either creating a new workflow from scratch (415) by using modules available in the library (420) or using an existing workflow from the server earlier saved by her/him or shared by other user(s) (425) and modifying it. Once the workflow is constructed with compatible modules it can be executed (425) or it can be saved in the repository (445). A workflow execution can be interrupted and saved with partially processed data. After the workflow has finished execution the results are displayed with the help of visualization tools (455). The workflow can be further modified (440) to improve and optimize the analysis. The results can be saved in the repository (450) for further analysis. After the user is finished using the VIBE-SE system, the application can be closed (460).

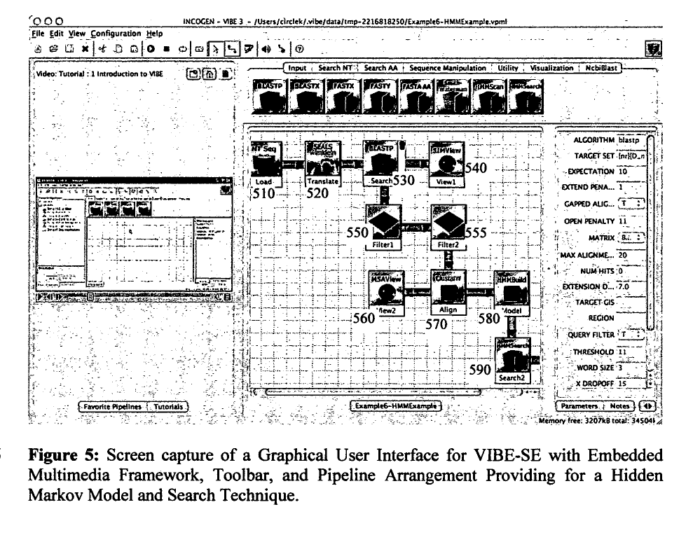

FIG. 5 is a screen capture of a graphical user interface (GUI) for the VIBE-SE system which includes an embedded multimedia framework, toolbar, and pipeline arrangement that in this case provides the use of a “Hidden Markov Model and Search Technique” (HMM). This complex analysis workflow shows the advantage of refining a similarity search. After loading the nucleotide sequence (510), the SEALS Wimklein module (520), allows for translation of the data prior to BLAST-ing (530) against the NR database. The results are then filtered (550, 555) on keyword and score using two conditional modules. Next, a multiple sequence alignment (570) is performed before the HMM is built (580) and used in the subsequent HMM search (590). Two viewers are also attached (540, 560) to visualize the intermediate results.

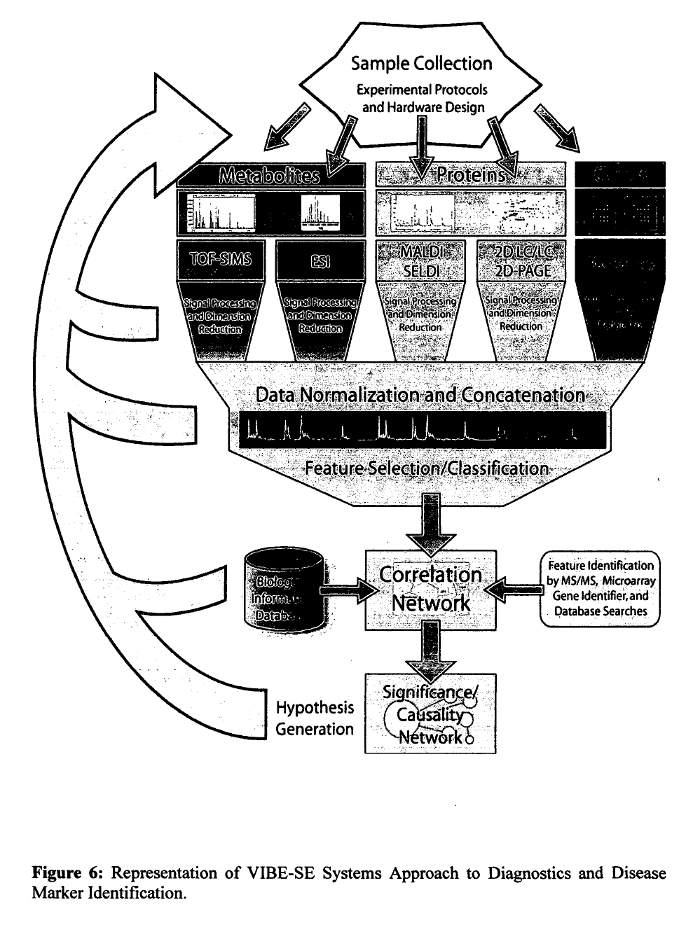

FIG. 6 is a graphical representation of the VIBE-SE systems approach to diagnostics and disease marker identification. It illustrates the sample collection effort and the use of various experimental platforms to obtain the metabolite, protein, and gene complements of that sample. Data obtained from each experimental platform will first be analyzed (signal processing and dimension reduction) with tools specific to that platform. Next the data will be normalized and concatenated, followed by further selection and classification. In the next step, a correlation/co fluctuation network is constructed. Information from biological databases and additional experimental evidence (protein identification using MS/MS, etc) is collected and used to augment the correlation network. The combination of the wetlab and computational platforms allows for optimization of the workflow, hypothesis generation, further experimental validation, and prediction of causality in the biological system. Optimization, as shown by the possibility of feedback loops (shown by the large arrow on the left side) can occur within any one of the general data reduction loops as shown.

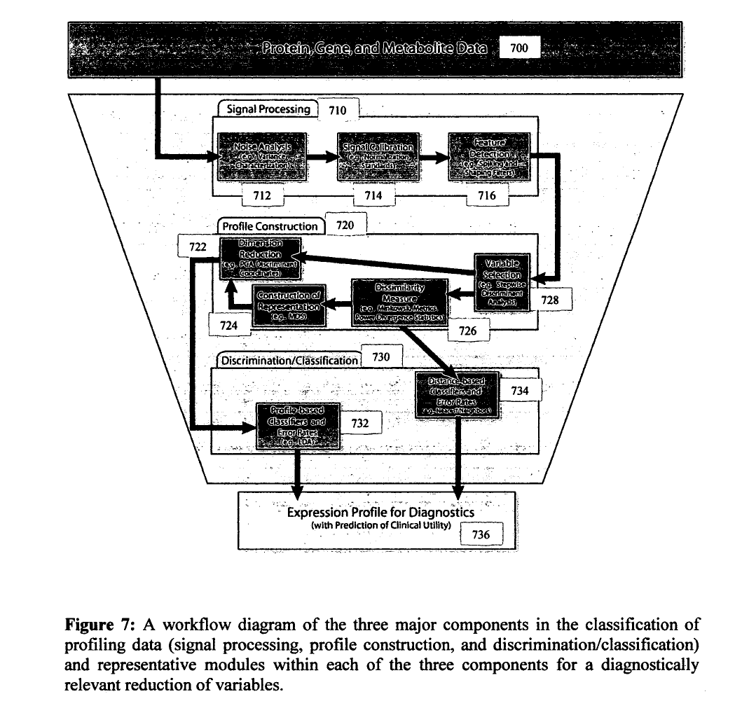

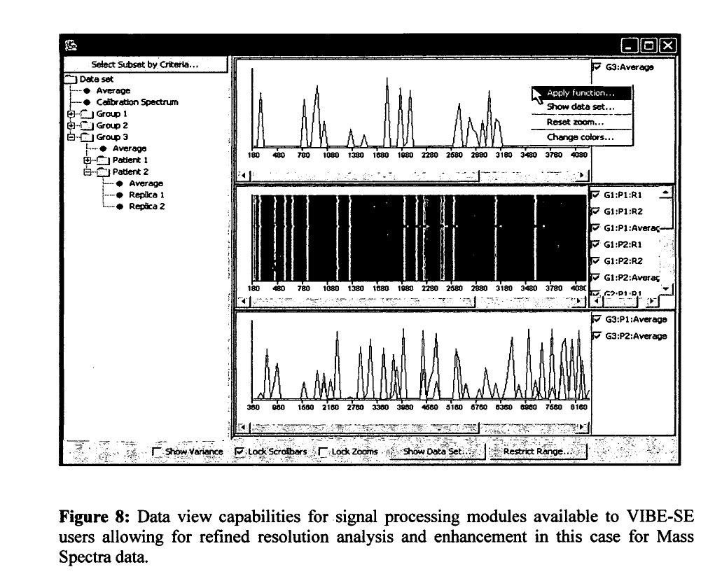

FIG. 7 is a workflow diagram of the three major components in the classification of profiling data—protein, gene, and metabolite data (700) (using signal processing, profile construction, and discrimination/classification). An example of the workflow utilizing the VIBE-SE application for analysis of mass spectrometry data was previously outlined and is graphically represented in this figure. The representative modules include signal processing (710) which comprises noise analysis (712), signal calibration (714), and feature detection (716). In profile construction (720), there are variable selection (728) and dimension reduction modules, as well as dissimilarity measurements (726) and construction of representation (724). The direction arrows indicate a typical workflow. Next, within the discrimination/classification module (730), the profile based classifiers and error rates module (732) normally accepts data from the dimension reduction module (722) and the distance-based classifiers and error rates module (734) normally accepts data directly from the dissimilarity measure (726) module. Both the profile-based classifiers and error rates (732) module and the distance-based classifiers and error rates (734) module contribute transcribed data to the expression profile for diagnostics (736) module where the information is summarized (and displayed) for the user. FIGS. 8-12 described below indicate the powerful use and display of these “expression profiles for diagnostics”.

FIG. 8 is a screen capture that shows the data view capabilities for signal processing modules available to VIBE-SE users allowing for refined resolution analysis and enhancement. In this case the refinement is directed to mass spectrometry data.

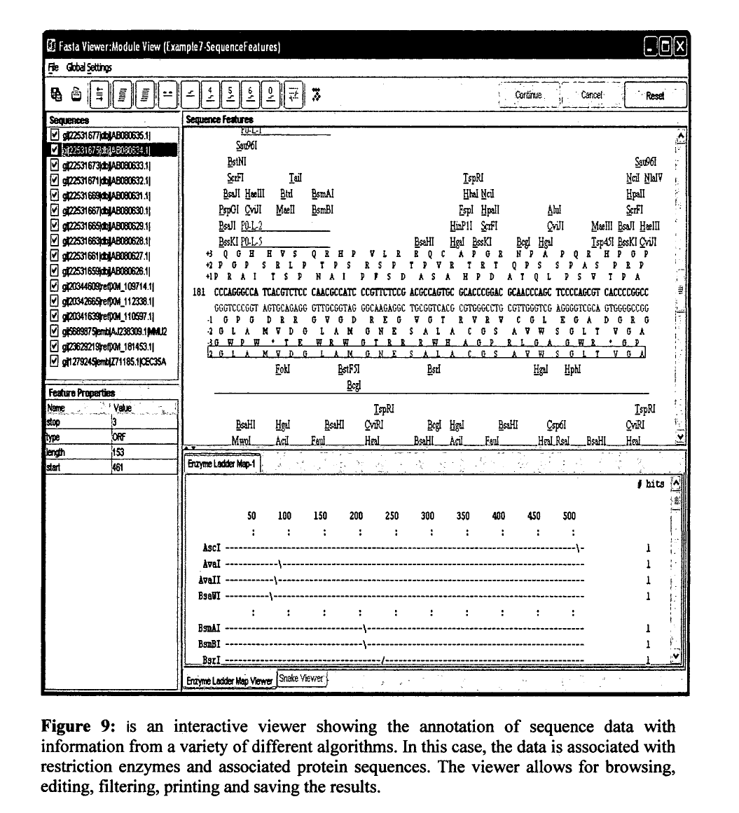

FIG. 9 is an interactive viewer showing the annotation of sequence data with information from a variety of different algorithms. In this case, the data is associated with restriction enzymes and associated protein sequences. The viewer allows for browsing, editing, filtering, printing and saving the results.

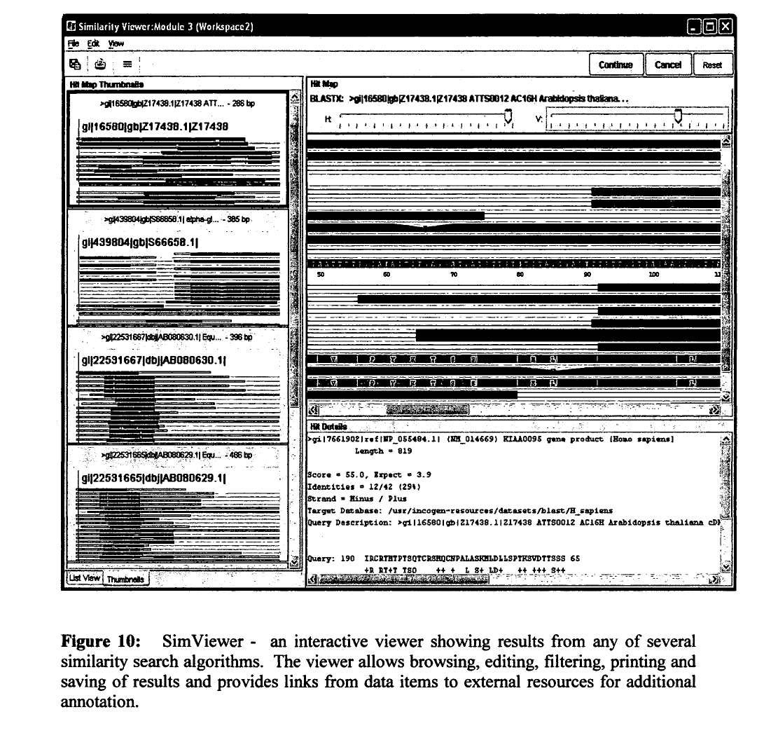

FIG. 10 is an interactive SimViewer showing results from any of several similarity search algorithms. The viewer allows browsing, editing, filtering, printing and saving of results and provides links from data items to external resources for additional annotation.

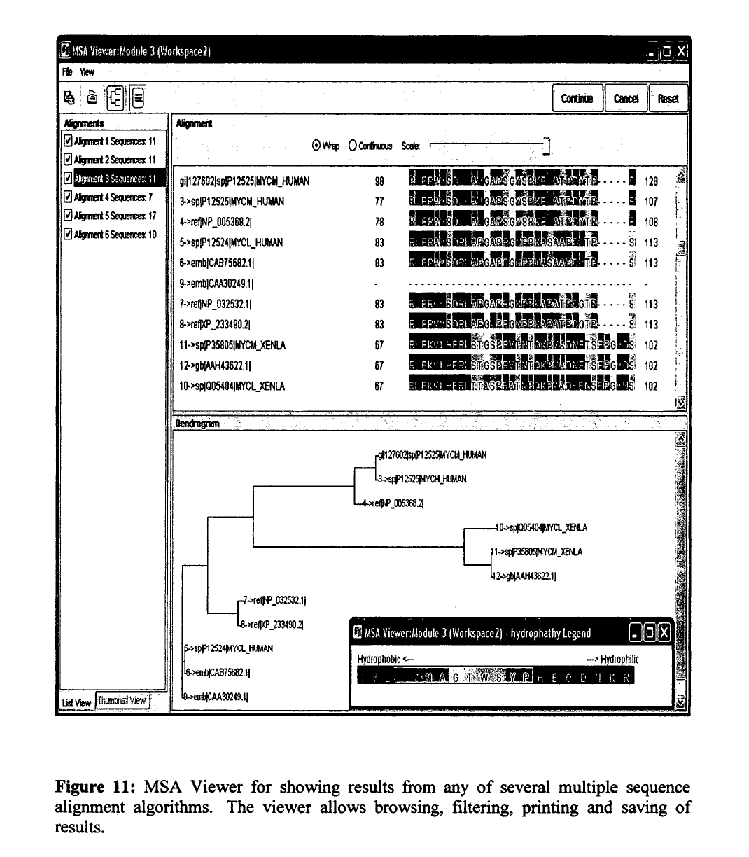

FIG. 11 is an interactive MSA viewer showing results from any of several multiple sequence alignment algorithms. The viewer allows browsing, filtering, printing and saving the results.

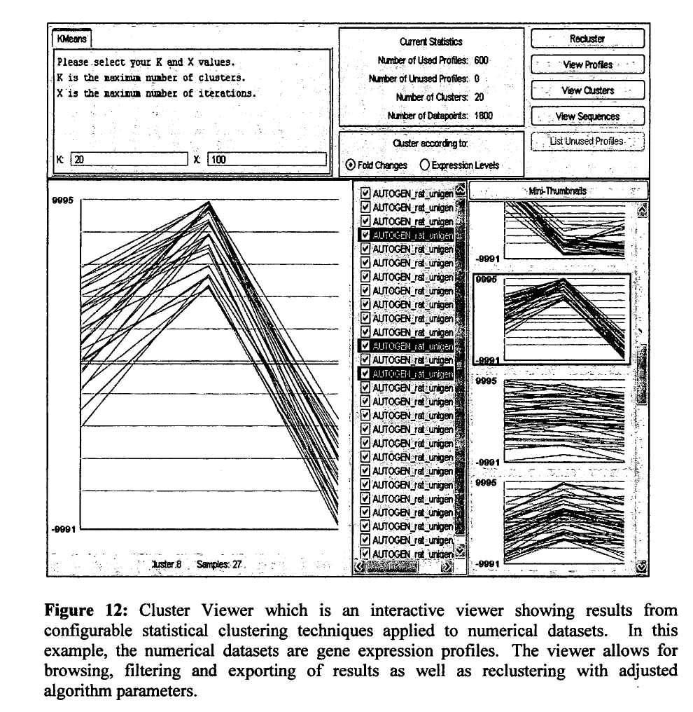

FIG. 12 is a screen capture of a “Cluster Viewer” which is an interactive viewer showing results from configurable statistical clustering techniques applied to numerical datasets. In this example, the numerical datasets are gene expression profiles. The viewer allows for browsing, filtering and exporting of results as well as reclustering with adjusted algorithm parameters.

We claim:

1. A computer-based visual or audio-visual system for characterization, analysis, and/or organization of genomic, transcriptomic, metabonomic, and proteomic data that provides for relationship networks among functionally significant said data, and;
deduces said data systematically from a larger volume set of data;
integrates information from existing databases into said relationship networks;
enables researchers to consolidate molecular profiling data from complementary experimental techniques;
constructs diagnostically significant molecular fingerprints from molecular profiling data;
optimizes an analysis workflow that provides said molecular fingerprints; and
provides feedback and/or direction for subsequent experiments to identify and/or validate potential biomarkers and drug targets.

2. The system of claim 1, wherein said system also provides for analysis of gene, metabolite, transcriptome, and protein profiling.

3. The system of claim 1, wherein said system also allows for obtaining genomic, transcriptomic, metabonomic, and proteomic signatures.

4. The system of claim 1, wherein said system also provides for disease diagnosis and classification, such as cancer, based on data obtained from experimental platforms including, but not limited to, mass spectrometry, 2D PAGE, liquid chromatography, sequence, protein array, and/or microarray gene expression.

5. The system of claim 4, wherein said system also provides cancer researchers with research based on efficient and intelligent integration of said data.

6. The system of claim 1, wherein said system also provides for recognition and characterization of pathogens.

7. A method comprising a visual or audio-visual based computer-network for
characterization, analysis, and/or organization of genomic, transcriptomic, metabonomic, and proteomic data that provides for relationship networks among functionally significant said data and;
deducing said data systematically from a larger volume set of data;
integrating information from existing databases into said relationship networks;
enabling researchers to consolidate molecular profiling data from complementary experimental techniques;
constructing diagnostically significant molecular fingerprints from molecular profiling data;
optimizing an analysis workflow that provides said molecular fingerprints; and
providing feedback and/or direction for subsequent experiments to identify and/or validate potential biomarkers and drug targets.

8. The method of claim 7, wherein said method is also allowing for providing for analysis of gene, metabolite, transcriptome, and protein profiling.

9. The method of claim 7, wherein said method is also allowing for obtaining genomic, transcriptomic, metabonomic, and proteomic signatures.

10. The method of claim 7, wherein said method is also allowing for cancer diagnosis based on data obtained from experimental platforms including, but not limited to, mass spectrometry, 2D PAGE, liquid chromatography, sequence, protein array, and/or microarray gene expression.

11. The method of claim 10, wherein said method is also providing cancer researchers with research based on efficient and intelligent integration of said data.

12. The method of claim 7, wherein said method also provides for recognition and characterization of pathogens

13. A life sciences visual or audio-visual programming environment system comprising:
a. zero or more server system(s);
b. one or more client system(s);
c. one or more computer processor(s) for receiving genomic, transcriptomic, metabonomic, and proteomic data and for receiving user input;
d. a repository of modules located on said client system and/or said server system;
e. a repository of workflow pipelines created by user(s) of said visual or audio-visual programming environment;
f. an interface to view a detailed description of said modules when said modules are selected and/or highlighted;
g. an error reporting tool that will alert said user(s) when an error is encountered within said visual or audio-visual programming environment;
h. one or more sharing utilities to allow said users of said visual or audio-visual programming environment to share resources including but not limited to said repository of modules, and said repository of workflow pipelines, directly between said client systems or via said server computer;
i. an auto-update tool that will update said client and/or said server system;
wherein said system provides for characterization and/or organization of genomic, transcriptomic, metabonomic, and proteomic data that assist in a development of relationship networks among functionally significant said data.

14. The client system and/or said server system of claim 13, wherein said modules are computer software programs and/or data sources with said visual or audio-visual programming environment or developed by said user or obtained from a third party.

15. The visual programming environment of claim 13, wherein said modules are represented as visual icons in formats including but not limited to tabbed toolbar format or tree format.

16. The sharing utility of claim 13, wherein said sharing utility is a computer software program incorporated in said visual or audio-visual programming environment that will allow said user to save said workflow pipeline(s) in a central repository which can be used by said user(s) of said visual or audio-visual programming environment.

17. The sharing utility of claim 13, wherein said user may retrieve said workflow pipeline(s) stored by other said user(s) of said visual or audio-visual programming environment.

18. The visual or audio-visual programming environment of claim 13, wherein said environment serves as an integrated development environment allowing interaction between said user(s) and said visual or audio-visual programming environment.

19. The interaction of claim 18, wherein said interaction includes but is not limited to development of said workflow pipeline(s), execution of said workflow pipeline(s), modification of said workflow pipeline(s), optimization of said workflow pipeline(s), testing of said workflow pipeline(s), validation of said workflow pipeline(s), and saving of said workflow pipeline(s).

20. The visual or audio-visual programming environment of claim 13, wherein said visual or audio-visual programming environment may optionally present an overview page that contains a description of utilities available within said visual or audio-visual programming environment.

21. The error reporting tool of claim 13, wherein said tool will direct said user to appropriate resource(s).

22. The autoupdate tool of claim 13, wherein said tool will automatically notify and optionally update said system comprising said client system and said server system by downloading components wherein said components are downloaded from a server.

23. The visual programming environment of claim 13, wherein said visual or audio-visual programming environment runs on any graphical user interface-based operating system including but not limited to Microsoft Windows, Linux, Sun Solaris and Mac OS that support a Java Virtual Machine.

24. The visual or audio-visual life science programming environment of claim 13, wherein computationally intensive tasks on said client system may optionally be sent to said server system.

25. A life sciences visual or audio-visual programming environment method comprising:
one or more computer processor(s) for receiving genomic, transcriptomic, metabonomic, and proteomic data and for receiving user input and including;
a. a repository of modules located on said client system and/or said server system;
b. a repository of workflow pipelines created by user(s) of said visual or audio-visual programming environment;
c. an interface to view a detailed description of said modules when said modules are selected and/or highlighted;
d. an error reporting tool that will alert said user(s) when an error is encountered within said visual or audio-visual programming environment;
e. one or more sharing utilities allowing said users of said visual or audio-visual programming environment to share resources including but not limited to said repository of modules, and said repository of workflow pipelines, directly between said client systems or via said server computer;
f. an auto-update tool updating said client and/or said server system;
wherein said method provides for characterization and/or organization of genomic, transcriptomic, metabonomic, and proteomic data that assist in a development of relationship networks among functionally significant said data.

26. The client system and/or said server system of claim 25, wherein said modules are computer software programs and/or data sources with said visual or audio-visual programming environment or developed by said user or obtained from a third party.

27. The visual programming environment of claim 25, wherein said modules are represented as visual icons in formats including but not limited to tabbed toolbar format or tree format.

28. The sharing utility of claim 25, wherein said sharing utility is a computer software program incorporated in said visual or audio-visual programming environment that will allow said user to save said workflow pipeline(s) in a central repository which can be used by said user(s) of said visual or audio-visual programming environment.

29. The sharing utility of claim 25, wherein said user may retrieve said workflow pipeline(s) stored by other said user(s) of said visual or audio-visual programming environment.

30. The visual or audio-visual programming environment of claim 25, wherein said environment serves as an integrated development environment allowing interaction between said user(s) and said visual or audio-visual programming environment.

31. The interaction of claim 30, wherein said interaction includes but is not limited to development of said workflow pipeline(s), modification of said workflow pipeline(s), optimization of said workflow pipeline(s), testing of said workflow pipeline(s), validation of said workflow pipeline(s), and saving of said workflow pipeline(s).

32. The visual or audio-visual programming environment of claim 25, wherein said visual or audio-visual programming environment may optionally present an overview page that contains a description of utilities available within said visual or audio-visual programming environment.

33. The error reporting tool of claim 25, wherein said tool will direct said user to appropriate resource(s).

34. The autoupdate tool of claim 25, wherein said tool will automatically notify and optionally update said method comprising said client system and said server system by downloading components wherein said components are downloaded from a server.

35. The visual programming environment of claim 25, wherein said visual or audio-visual programming environment runs on any graphical user interface based operating system including but not limited to Microsoft Windows, Linux, Sun Solaris and Mac OS that support Java Virtual Machine.

36. The visual or audio-visual life science programming environment of claim 25, wherein computationally intensive tasks on said client system may optionally be sent to said server system.
